(19) United States
(12) Patent Application Publication
(10) Pub. No.: US 2015/0130833 A1
(43) Pub. Date: May 14, 2015

(54) MAP SUPERPOSITION METHOD AND ELECTRONIC DEVICE

(71) Applicants: BEIJING LENOVO SOFTWARE LTD., Beijing (CN); LENOVO (BEIJING) LIMITED, Beijing (CN)

(72) Inventor: Yufeng MAO, Beijing (CN)

(73) Assignees: LENOVO (BEIJING) LIMITED, Beijing (CN); BEIJING LENOVO SOFTWARE LTD., Beijing (CN)

(21) Appl. No.: 14/497,443

(22) Filed: Sep. 26, 2014

(30) Foreign Application Priority Data
Nov. 8, 2013 (CN) 201310554217.2

(51) Int. Cl. G06T 11/60

(52) U.S. Cl. CPC G06T 11/60
USPC 345/632

(57) ABSTRACT

The embodiments of the present disclosure relate to electronic technology and provide a map superposition method and an electronic device, capable of solving the problem associated with low positioning accuracy and limited information available for users due to lack of detailed map information on a small area. A first image is obtained. First identification information contained in the first image and second identification information contained in a first map are adjusted and compared. The first image is superimposed on the first map to obtain a second map when the comparison indicates that a predetermined condition is satisfied. Operations associated with a map application are performed based on the second map. The embodiments of the present disclosure solves the problem associated with low positioning accuracy and limited information available due to lack of detailed map information on a small area and improves the user experience.

### TECHNICAL FIELD

The present disclosure relates to electronic technology, and more particularly, to a map superposition method and an electronic device.

### BACKGROUND

Map software currently available on market can provide users with various functions such as positioning, navigating and guiding based on two-dimensional (2D), three-dimensional (3D) and satellite map layers included therein, in conjunction with e.g., a GPS module in an electronic device. However, conventional maps contain rough descriptions for small areas such as residential areas and scenic spots areas and thus can only provide a limited amount of related map information. Hence, when a user is located in such an area, the positioning accuracy is low and cannot satisfy the user's basic requirements, resulting in inconvenience in use.

### SUMMARY

It is an object of the present disclosure to provide a map superposition method and an electronic device, capable of solving the problem associated with low positioning accuracy and limited information available for users due to lack of detailed map information on a small area, and improving the user experience.

In order to achieve the above object, the following solutions are provided according to the embodiments of the present disclosure.

In an aspect, a map superposition method is provided. The method is applied in an electronic device and comprises: obtaining a first image containing first map information and first identification information; obtaining a first map containing second map information and second identification information; and adjusting and comparing the first identification information and the second identification information and, if the first identification information and the second identification information satisfy a predetermined condition, superimposing the first image on the first map to obtain a second map.

In another aspect, an electronic device is provided. The electronic device comprises: a first obtaining module configured to obtain a first image containing first map information and first identification information; a second obtaining module configured to obtain a first map containing second map information and second identification information; and a comparing and superimposing module configured to adjust and compare the first identification information and the second identification information and superimpose, if the first identification information and the second identification information satisfy a predetermined condition, the first image on the first map to obtain a second map.

The embodiments of the present disclosure provide a map superposition method and an electronic device. A first image is obtained. First identification information contained in the first image and second identification information contained in a first map are adjusted and compared. The first image is superimposed on the first map to obtain a second map when the comparison indicates that a predetermined condition is satisfied. Operations associated with a map application are performed based on the second map. The embodiments of the present disclosure solve the problem associated with low positioning accuracy and limited information available for users due to lack of detailed map information on a small area and improve the user experience.

### BRIEF DESCRIPTION OF THE DRAWINGS

In order to illustrate the solutions according to the embodiments of the present disclosure or the prior art in further detail, the figures used for description of the embodiments or the prior art will be introduced briefly here. Obviously, the figures described below are only some, rather than all, of the embodiments. It is apparent to those skilled in the art that other figures can be obtained from the figures introduced below without applying any inventive efforts.

FIG. 1 is a flowchart illustrating a map superimposition method according to an embodiment of the present disclosure;

FIG. 2 is a flowchart illustrating another map superimposition method according to an embodiment of the present disclosure; and

FIG. 3 is a schematic diagram showing a structure of an electronic device according to an embodiment of the present disclosure.

### DETAILED DESCRIPTION OF THE EMBODIMENTS

In the following, the embodiments of the present disclosure will be described in further detail with reference to the figures. The following embodiments are provided for explaining the present disclosure, rather than limiting the scope thereof. Obviously, the embodiments described below are only some, rather than all, of the embodiments. Starting from the embodiments of the present disclosure, those skilled in the art can obtain other embodiments with applying any inventive efforts. All these embodiments are to be encompassed by the scope of the present disclosure.

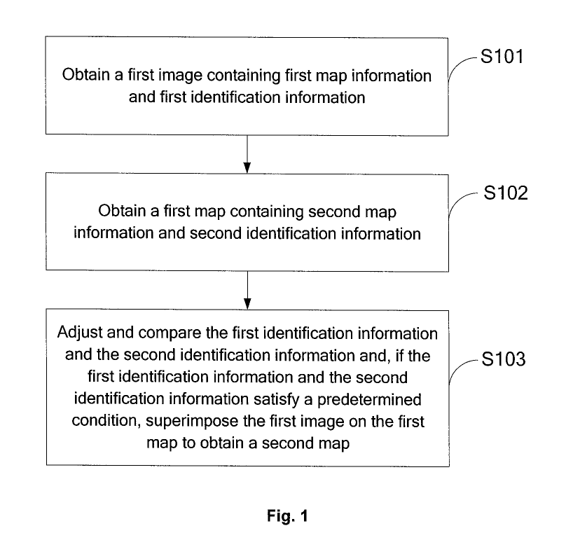

According to an embodiment of the present disclosure, a map superposition method is provided. The method is applied in an electronic device. As shown in FIG. 1, the method includes the following steps.

At step S101, a first image containing first map information and first identification information is obtained.

At step S102, a first map containing second map information and second identification information is obtained.

At step S103, the first identification information and the second identification information are adjusted and compared and, if the first identification information and the second identification information satisfy a predetermined condition, the first image is superimposed on the first map to obtain a second map.

The embodiment of the present disclosure provides a map superposition method. A first image is obtained. First identification information contained in the first image and second identification information contained in a first map are adjusted and compared. The first image is superimposed on the first map to obtain a second map when the comparison satisfies a predetermined condition. Operations associated with a map application are performed based on the second map. The embodiments of the present disclosure solve the problem associated with low positioning accuracy and limited information available for due to lack of detailed map information on a small area and improve the user experience.

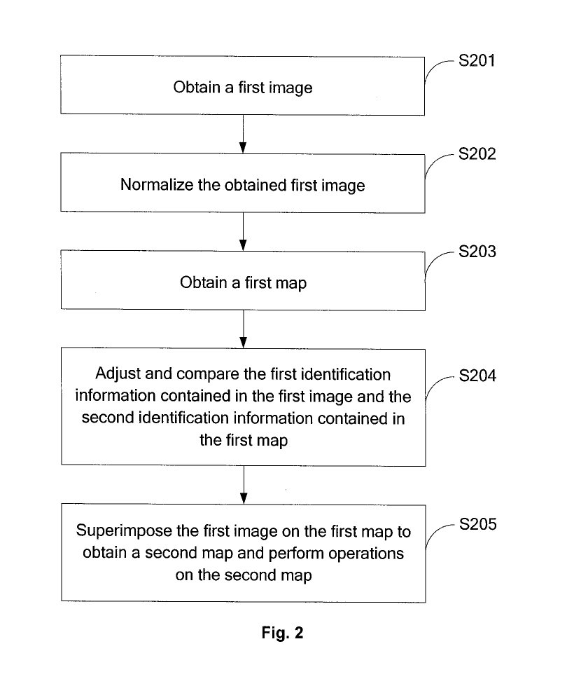

According to an embodiment of the present disclosure, another map superposition method is provided. The method is applied in an electronic device. As shown in FIG. 2, the method includes the following steps.

At step S201, the electronic device obtains a first image.

In particular, the first image can be obtained using an image capture module of the electronic device. Alternatively, an image stored in the electronic device or acquired by the electronic device from an external device can be loaded as the first image. The first image contains first map information and first identification information.

For example, a mobile phone or a tablet computer having a camera function can be used to capture, as the first image, an image containing desired map information, such as a paper map, a layout graph or a guide map of a scenic spot area. Alternatively, when the mobile phone or the tablet computer has such image containing desired map information already stored in its memory, the stored image can be loaded directly from the memory as the first image. As another alternative, when the mobile phone or the tablet computer is equipped with an external storage (e.g., a USB memory, a memory card or any other memory connected in a wired or wireless manner) or a network access function, such image containing desired map information can be loaded from the external storage or a networked device as the first image.

The first identification information contained in the first image may include a first road, a scale and location information of the first road, road indication information, building indication information, terrain indication information and other information for identification and indication. The first identification information as listed here is exemplary only and the present disclosure is not limited thereto.

The first map information contained in the first image may include information regarding a road, buildings along a road, a scenic spot, a facility, traffic and other information on name/data. The first map information as listed here is exemplary only and the present disclosure is not limited thereto.

At step S202, the obtained first image is normalized.

In particular, depending on the view angle or orientation of the image, the image captured by the image capture module of the electronic device or loaded from the internal/external memory of the device may need to be normalized before it can be used for subsequent operations.

For example, the normalization process may include: recognizing the image and correcting a geometric distortion of the image due to instability during the image capturing, e.g., restoring a route tilted due to tilt during the image capturing into an upright route, by applying basic operations such as stretching, rotating and cutting; and adjusting a geographical azimuth indicated by contents shown in the image to be consistent with the standard map azimuth, e.g., by rotating the north direction indicated by contents shown in the image to the upward direction of the image. The normalization process as listed here is exemplary only and the present disclosure is not limited thereto.

At step S203, the electronic device obtains a first map.

In particular, the step S203 of obtaining the first map may include: obtaining current location information of the electronic device using a positioning function of the electronic device; and obtaining, as the first map, a map image of a predetermined area based on the current location information.

Alternatively, the step S203 of obtaining the first map may include receiving location information inputted from a user; and obtaining, as the first map, a map image within a range of a predetermined area based on location information inputted from the user.

Here, the first map contains second map information and second identification information. The range of the predetermined area can be preconfigured by the user or can be a maximum range the map image can provide.

For example, when the user carries the electronic device in the range of an area such as a residential area or a scenic spot area, the current location information of the electronic device can be obtained using the positioning function of the electronic device. Further, an area of a predetermined range surrounding the current location can be determined. Based on the predetermined range of area, a map image within the predetermined range of area can be obtained as the first map.

Alternatively, when the user carries the electronic device outside the range of an area such as a residential area or a scenic spot area, he/she can input target location information by searching for a name of place or manually dragging a map. Further, an area of a predetermined range can be determined based on the target location information. Based on the predetermined range of area, a map image within the predetermined range of area can be obtained as the first map.

As an example, the second identification information contained in the first map may include a second road, a scale and location information of the second road, road indication information, building indication information, terrain indication information and other information for identification and indication. The second identification information as listed here is exemplary only and the present disclosure is not limited thereto.

The second map information contained in the first image may include information regarding a road, buildings along a road, a scenic spot, a facility, traffic and other information on name/data. The second map information as listed here is exemplary only and the present disclosure is not limited thereto.

At step S204, the first identification information contained in the first image and the second identification information contained in the first map are adjusted and compared.

In particular, the step of adjusting and comparing the first identification information and the second identification information may include adjusting and comparing the first road and the second road. After the electronic device has obtained the first image and the first map, the scale of the first road and/or the scale of the second road is/are adjusted, such that the scales of the first and second roads become equal to each other. Further, a positional relation between the first image and the first map is adjusted until the location information of the first road and the location information of the second road become identical to each other and finally the first identification information and the second identification information satisfy the predetermined condition.

Here, the display scale(s) of the first image and/or the first map can be set by the user, e.g., by manually inputting the specific value(s) of the display scale(s) of the first image and/or the first map or scaling up or down the first image and/or the first map with a gesture of his/her finger, so as to adjust the scale of the first road and/or the scale of the second road.

The positional relation between the first image and the first map can be adjusted by the user, e.g., by manually inputting the specific coordinate values (which may be longitude and latitude values) of the first image and/or the first map or dragging/moving longitude and latitude with a gesture of his/her finger, so as to adjust the positional relation between the first image and the first map.

The predetermined condition may be satisfied when the scales of the first and second roads become equal to each other and the location information of the first road and the location information of the second road become identical to each other.

For example, during the above adjustment, the electronic device identifies features such as the first road in the first identification information and the second road in the first map and compares these features from the first identification information and the second identification information, respectively. When the conformity between these features such as the first road and the second road exceeds a predetermined value, it can be determined that the first identification information and the second identification information satisfy the predetermined condition. Alternatively, when the first identification information in the first image and the second identification information in the first map do not contain sufficient features for identification and comparison, the user may manually perform the adjustment and finally confirm the adjustment. In response to receiving a confirmation instruction from the user, the electronic device can determine that the first identification information and the second identification information satisfy the predetermined condition.

At step S205, the first image is superimposed on the first map to obtain a second map and operations are performed on the second map.

In particular, when the first identification information in the first image and the second identification information in the first map satisfy the predetermined condition, the first image is superimposed on the first map to obtain the second map which contains both the first map information from the first image and the second map information from the first map, thereby allowing operations to be performed on the second map.

For example, a new map layer can be created, such that the first image can be superimposed on the first map at corresponding locations on the new map layer and the new map layer can serve as the second map. Alternatively, the first image can be superimposed on the first map at corresponding locations and the resulting map can serve as the second map.

For example, the step of performing operations on the second map obtained by means of superimposition may include performing a positioning operation on the second map. For example, when the user is located in a range of an area, such as a residential area or a scenic spot area, for which the first map fails to provide sufficient map information, the current specific position of the user on the second map can be determined and indicated. For example, based on the current specific position of the user on the second map, the user may be provided with detailed information regarding the surrounding area that would not be available from the first map alone.

The operations performed on the second map obtained by means of superimposition as listed above are exemplary only and the present disclosure is not limited thereto.

The embodiment of the present disclosure provides a map superposition method. A first image is obtained. First identification information contained in the first image and second identification information contained in a first map are adjusted and compared. The first image is superimposed on the first map to obtain a second map when the comparison indicates that a predetermined condition is satisfied. Operations associated with a map application are performed based on the second map. The embodiments of the present disclosure solve the problem associated with low positioning accuracy and limited information available for users due to lack of detailed map information on a small area and improve the user experience.

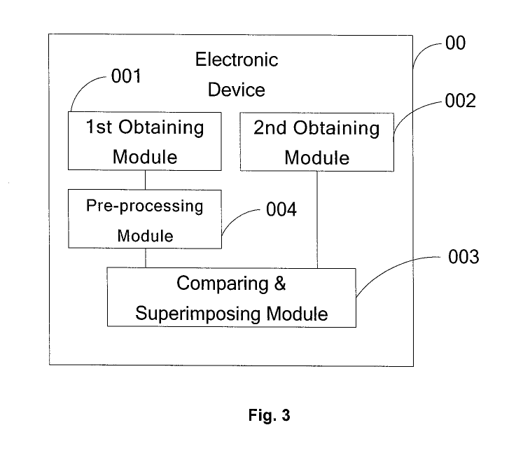

According to a further embodiment of the present disclosure, an electronic device 00 is provided. As shown in FIG. 3, the electronic device 00 includes the following modules.

A first obtaining module 001 is configured to obtain a first image containing first map information and first identification information.

A second obtaining module 002 is configured to obtain a first map containing second map information and second identification information.

A comparing and superimposing module 003 is configured to adjust and compare the first identification information and the second identification information and to superimpose, if the first identification information and the second identification information satisfy a predetermined condition, the first image on the first map to obtain a second map.

Further, the first obtaining module 001 is configured to: obtain the first image using an image capture module of the electronic device 00; or load, as the first image, an image stored in the electronic device or acquired by the electronic device 00 from an external device.

Optionally, the first identification information includes a first road and a scale and location information of the first road, and the second identification information includes a second road and a scale and location information of the second road.

The comparing and superimposing module 003 is configured to: adjust the scale of the first road and/or the scale of the second road, such that the scales of the first and second roads become equal to each other; adjust a positional relation between the first image and the first map and determine that the first identification information and the second identification information satisfy the predetermined condition when the location information of the first road and the location information of the second road become identical to each other, or determine that the first identification information and the second identification information satisfy the predetermined condition in response to receiving a confirmation instruction from a user.

The comparing and superimposing module 003 is further configured to: superimpose the first map information of the first image onto the first map to obtain the second map which contains both the first map information and the second map information. Each of the first and second map information contains information regarding at least one of: a road, buildings along a road, a scenic spot, a facility and traffic.

Optionally, the electronic device 00 further includes a pre-processing module 004 configured to normalize the first image before the first identification information and the second identification information are adjusted and compared.

The electronic device as described above can be a mobile phone, a tablet computer, a Personal Digital Assistant (PDA) or any other electronic device having a similar structure.

The embodiment of the present disclosure provides an electronic device. A first image is obtained. First identification information contained in the first image and second identification information contained in a first map are adjusted and compared. The first image is superimposed on the first map to obtain a second map when the comparison indicates that a predetermined condition is satisfied. Operations associated with a map application are performed based on the second map. The embodiments of the present disclosure solve the problem associated with low positioning accuracy and limited information available for users due to lack of detailed map information on a small area and improve the user experience.

It can be appreciated from the embodiments of the present application that the disclosed electronic device and method can be implemented in alternative ways. The electronic device embodiments as described above are illustrative only. For example, while the modules have been divided in accordance with their logical functions, other divisions are possible in practice. In addition, the connection between various modules as shown or discussed may be achieved via some interfaces which can be electrical, mechanical or in another form.

The units described above as separated may or may not be physically separated. The units may or may not be physical units. Depending on actual requirements, some or all of the modules can be selected to achieve the object of the present disclosure.

Further, all the functional modules in various embodiments of the present disclosure can be integrated within one processing module, or each of these modules can be a separate module, or two or more modules can be integrated into one module. Such integrated module can be implemented in hardware, possibly in combination with software functional modules.

The integrated modules described above as implemented in software functional units can be stored in a computer readable storage medium. The software functional modules can be stored in a storage medium containing instructions which cause a computer device (which can be a personal computer, a server, a network device or the like) to perform some steps of one or more methods according to the embodiments of the present application. The storage medium may be any of various medium capable of storing program codes, such as a USB memory, a removable hard disk, a Read Only Memory (ROM), a Random Access Memory (RAM), a magnetic disk or an optical disc.

While the embodiments of the present disclosure have been described above, the scope of the present disclosure is not limited thereto. Various modifications and alternatives can be made by those skilled in the art without departing from the scope of the present disclosure. These modifications and alternatives are to be encompassed by the scope of the present disclosure which is only defined by the claims as attached.

What is claimed is:

1. A map superposition method applied in an electronic device, the method comprising:
obtaining a first image containing first map information and first identification information;
obtaining a first map containing second map information and second identification information; and
adjusting and comparing the first identification information and the second identification information and, if the first identification information and the second identification information satisfy a predetermined condition, superimposing the first image on the first map to obtain a second map.

2. The method of claim 1, wherein said obtaining the first image comprises:
obtaining the first image using an image capture module of the electronic device; or
loading, as the first image, an image stored in the electronic device or acquired by the electronic device from an external device.

3. The method of claim 1, wherein the first identification information comprises a first road and a scale and location information of the first road, and the second identification information comprises a second road and a scale and location information of the second road, and
wherein said adjusting and comparing the first identification information and the second identification information comprises:
adjusting the scale of the first road and/or the scale of the second road, such that the scales of the first and second roads become equal to each other;
adjusting a positional relation between the first image and the first map and determining that the first identification information and the second identification information satisfy the predetermined condition when the location information of the first road and the location information of the second road become identical to each other, or
determining that the first identification information and the second identification information satisfy the predetermined condition in response to receiving a confirmation instruction from a user.

4. The method of claim 1, further comprising, prior to said adjusting and comparing the first identification information and the second identification information:
normalizing the first image.

5. The method of claim 1, wherein said superimposing the first image on the first map to obtain the second map comprises:
superimposing the first map information of the first image onto the first map to obtain the second map which contains both the first map information and the second map information, and
wherein each of the first and second map information contains information regarding at least one of: a road, buildings along a road, a scenic spot, a facility and traffic.

6. An electronic device, comprising:
a first obtaining module configured to obtain a first image containing first map information and first identification information;
a second obtaining module configured to obtain a first map containing second map information and second identification information; and
a comparing and superimposing module configured to adjust and compare the first identification information and the second identification information and to superimpose, if the first identification information and the second identification information satisfy a predetermined condition, the first image on the first map to obtain a second map.

7. The electronic device of claim 6, wherein the first obtaining module is configured to:
obtain the first image using an image capture module of the electronic device; or
load, as the first image, an image stored in the electronic device or acquired by the electronic device from an external device.

8. The electronic device of claim 6, wherein the first identification information comprises a first road and a scale and location information of the first road, and the second identification information comprises a second road and a scale and location information of the second road, and
wherein the comparing and superimposing module is configured to:
adjust the scale of the first road and/or the scale of the second road, such that the scales of the first and second roads become equal to each other;
adjust a positional relation between the first image and the first map and determine that the first identification information and the second identification information satisfy the predetermined condition when the location information of the first road and the location information of the second road become identical to each other, or
determine that the first identification information and the second identification information satisfy the predetermined condition in response to receiving a confirmation instruction from a user.

9. The electronic device of claim 6, further comprising:
a pre-processing module configured to normalize the first image before the first identification information and the second identification information are adjusted and compared.

10. The electronic device of claim 6, wherein the comparing and superimposing module is further configured to:
superimpose the first map information of the first image onto the first map to obtain the second map which contains both the first map information and the second map information, and
wherein each of the first and second map information contains information regarding at least one of: a road, buildings along a road, a scenic spot, a facility and traffic.
